(19) United States
(12) Patent Application Publication
(10) Pub. No.: US 2026/0358528 A1
(43) Pub. Date: Nov. 12, 2026

(54) DIELECTRIC INTREPETATION FOR WETTABILITY INFERENCE

(71) Applicant: SCHLUMBERGER TECHNOLOGY CORPORATION, Sugar Land, TX (US)

(72) Inventors: Chang-Yu HOU, Cambridge, MA (US); Jiang QIAN, University Heights, OH (US); Lalitha VENKATARAMANAN, Cambridge, MA (US); Laurent MOSSE, Paris (FR); Wael ABDALLAH, Sugar Land, TX (US); Shouxiang Mark Ma, Dhahran (SA)

(21) Appl. No.: 19/125,742

(22) PCT Filed: Oct. 31, 2023
(86) PCT No.: PCT/US2023/036382

§ 371 Date: Apr. 30, 2025

Related U.S. Application Data
(60) Provisional application No. 63/381,945, filed on Nov. 2, 2022.

(51) Int. Cl. G01V 3/38; G01V 3/26; G01V 20/00

(52) U.S. Cl. CPC G01V 3/38; G01V 3/26; G01V 20/00

(57) ABSTRACT

Embodiments presented provide for a method of interpretation for geological parameters. The method may comprise obtaining dielectric dispersion signals of a formation and obtaining a total porosity of the formation. The method may also comprise obtaining a dielectric dispersion model that includes a polarization response of trapped water droplets to indicate a wettability change of the formation and processing the dielectric dispersion signals and the total porosity of the formation with the model to determine a wettability state of rock in the formation.

### CROSS-REFERENCE TO RELATED APPLICATIONS

The present application claims priority to U.S. Provisional Patent Application 63/381,945 filed Nov. 2, 2022, the entirety of which is incorporated herein by reference.

### FIELD OF THE DISCLOSURE

Aspects of the disclosure relate to determination of physical properties of geological formation. More specifically, aspects of the disclosure relate to a method to infer wettability properties of rock formations using multi-frequency complex dielectric signals.

### BACKGROUND

Wettability is a parameter that affects not only reserve estimate but certainly reservoir production and its management plans. Wettability is defined as the preference of a solid to be in contact with one fluid rather than another (Abdallah et al., 2007). The general qualification of a reservoir being preferably water-wet, hydrocarbon (HC)-wet or neutral-wet is not sufficient for accurate production planning, and more quantitative assessment is required.

Laboratory core-based measurements using established industry accepted techniques such as contact angle, Amott-Harvey and US Bureau of Mines (USBM) provide information about wettability indices, but they do not necessarily represent actual reservoir-wettability conditions, because wettability of cores measured in the lab may already be altered during coring and later on core processing, before wettability measurement. Downhole formation wettability measurement is both required and desirable. Many petrophysical measurements, resistivity, dielectric dispersion, and nuclear magnetic resonance (NMR) are sensitive to wettability, but wettability cannot always be unambiguously derived from these measurements. A comprehensive review on the topic can be found in open literature (Abdallah et al., 2007; Valori et al., 2017; Al-Ofi et al., 2017; Valori et al. 2018; Al-Ofi et al., 2018). As shown in FIG. 1, wettability changes impact the measured dielectric dispersion response in the frequency range accessible by the modern logging tools (Venkataramanan et. al, 2014). However, the major difficulty of utilizing multi-frequency dielectric signals to infer the formation wettability, as highlighted by many (Bona et. al, 2001; Gkortsas et al., 2015; Al-Ofi et al., 2017), is the separation of the influences of fluid saturation, fluid distribution, water salinity and wettability on dielectric dispersion data.

There is a need to provide an apparatus and methods that easier to operate than conventional apparatus and methods.

There is a further need to provide apparatus and methods that do not have the drawbacks discussed above.

There is a still further need to reduce economic costs associated with operations and apparatus described above with conventional tools.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment of the disclosure, a method is disclosed. The method may comprise obtaining dielectric dispersion signals of a formation and obtaining a total porosity of the formation. The method may also comprise obtaining a dielectric dispersion model that includes a polarization response of trapped water droplets to indicate a wettability change of the formation; and processing the dielectric dispersion signals and the total porosity of the formation with the model to determine a wettability state of rock in the formation.

In an embodiment, a computer readable storage medium having data stored therein representing software executable by a computer is disclosed. The software may include instructions for obtaining dielectric dispersion signals of a formation by obtaining a total porosity of the formation, obtaining a dielectric dispersion model that includes a polarization response of trapped water droplets to indicate a wettability change of the formation, and processing the dielectric dispersion signals and the total porosity of the formation with the model to determine a wettability state of rock in the formation.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 shows a complex dielectric dispersion of a same core in different wettability stages.

FIG. 2 are schematical plots of three possible first stage constructions by including different shaped water droplets into a rock matrix/hydrocarbon background.

FIG. 3 shows three schematic plots of three possible constructions at the second stage for the inclusion of matrix/HC/water droplet composite into the conductive background.

FIG. 4 are graphs of typical relative permittivity and conductivity dispersion in 1-1000 MHz for the two-stage BM-BM construction, with varying amounts of ETWF.

FIG. 5 are graphs of typical relative permittivity and conductivity dispersion in 1-1000 MHz for the two stage LN-LN construction, with varying amounts of ETWF.

FIG. 6 is a set of graphs of joint fit results for dielectric dispersion data shown in FIG. 1.

FIG. 7 is a graph of fitting studies on simulated LN-LN model data with p_{tw}=0.45.

FIG. 8 is a set of graphs of inverted φ_{w}(p_{tw})=0.45 for simulated dielectric dispersions of a water-wet and HC wet case.

FIG. 9 is a proposed workflow for delineating the wettability states of a formation.

FIG. 10 is a graph of inverted φ_{w}(p_{tw}) for six water wet cores from their measured dielectric dispersion following the workflow of FIG. 9.

FIG. 11 is a graph of inverted φ_{w}(p_{tw}) for four HC-wet cores from measured dielectric dispersion following the workflow of FIG. 9.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure describe a method of inferring the wettability properties of rock formation utilizing the multi-frequency complex dielectric signals in a few MHz to a few GHz range. Dielectric signals are readily measured by the existing multi-frequency dielectric logging tool in the downhole environment, which allows the in-situ evaluation of the formation wettability properties. To capture the effect of wettability on multi-frequency dielectric signals, a series of new dielectric dispersion models are developed using the trapped/isolated water droplets as a proxy to indicate the hydrocarbon-wetting preference level of the formation. Namely, a higher trapped water fraction is used to indicate a more hydrocarbon-wet formation. Utilizing these newly developed models, a workflow is disclosed to delineate the wettability properties of formations based on the qualitatively different model inversion response for water-wet and for hydrocarbon-wet formations.

Two technical challenges need to be addressed to develop a workflow for inferring the formation wettability properties from multi-frequency complex dielectric signals. First, one needs to construct a dielectric forward model that captures the effect of wettability. In the literature, several attempts have been made to examine how existing dielectric models perform for rocks with different wettability conditions (Gkortsas et. al, 2015; Al-Ofi et. al, 2017). Because these dielectric models are essentially established for water-wet rocks, they give either little, or at best, qualitative indication of the wettability changes of the rock. From these studies, it becomes apparent that retooling water-wet dielectric models for the purpose of detecting the wettability changes have their limitations inherent from the model construction principles.

A second challenge is to predict the wettability from the measured dielectric data. Although previous work has shown that dielectric measurements are sensitive to wettability, model parameters relevant to wettability may not be robustly inverted for from the measured permittivity and conductivity dispersion responses. Part of this difficulty may reside in the problem formulation of the forward model which did not adequately capture the physics and part of this difficulty may result from the ill-posed nature of the inversion problem. Hence, to establish a workflow for inferring the wettability from multi-frequency complex dielectric signals, one needs to develop a dielectric dispersion model that is consistent with the expected fluid (re) distribution due to the wettability change, and to create an inversion procedure that offers a reliably signal to distinguish formations in different wettability states.

The multi-frequency complex dielectric downhole logging tools in 10-1000 MHZ range have been developed and used to probe formation petrophysical properties. Several other electromagnetic logging tools, such as some resistivity borehole image tools and LWD tools, potentially offer the formation complex dielectric signals in 1-50 MHz range. Conventionally, the multi-frequency complex dielectric signals are used to infer water saturation, brine salinity, water phase tortuosity exponent and cation exchange capacity in the presence of clay minerals. It has been observed that the change of formation wettability will affect its complex dielectric properties. However, no concrete workflow is established to enable the inference of the formation wettability properties from multi-frequency complex dielectric signals from existing tools in 1-1000 MHz frequency range.

A series of new dielectric dispersion models in the frequency range of a few MHz to a few GHz is established by explicitly including trapped (isolated) water droplets to mimic the fluid distribution of the hydrocarbon-wet formation. In a water-wet rock, conventional wisdom indicates that all water phases are connected and contribute to the electric conduction processes even with extremely low water saturation. Effectively, the presence of trapped water droplets is used as an indicator for the wettability changes.

To be consistent, all potential models are governed by the following common set of parameters associated with the rock properties:
∈ₘ: The relative permittivity of the non-conductive rock matrix.
∈_{HC}: The relative permittivity of typically non-conductive hydrocarbon
φ_{T}: The total porosity of the rock.
S_{w}: The water fraction of pore space, 0<S_{w}≤1.
Sal_{w}: The brine salinity. Together with the temperature and pressure, this allows us to infer the brine conductivity ow and relative permittivity σ_{w} Often, one combines them to denote the complex dielectric constant of brine as

$${ε}_{w} = {ϵ}_{w} + i \frac{{σ}_{w}}{{ϵ}_{0} ω} .$$

Here, ∈₀ is the vacuum permittivity and ω is the radial frequency.
p_{tw}: the Effective Trapped Water Fraction (ETWF) among all water volume, 0≤p_{tw}<1.

Besides these common parameters, two more texture parameters, which governs how the dielectric polarizations effect are introduced in various models and will be defined later for each model, are needed to build the dielectric models. Compared to the conventional dielectric dispersion models for water-wet formations in this frequency range, the new dielectric models only increase one more parameter, the ETWF, p_{tw}. Based on these parameters, the water residing in the pore space of rocks is “effectively” separated into two parts: the trapped (isolated) water droplets with their volume as φ_{T}S_{w}p_{tw} and the contiguous water phase with its volume as φ_{T}S_{w}(1−p_{tw}).

Due to the insulation nature and due to relatively smaller permittivity contrast of the typical rock matrix and the hydrocarbon, an effective permittivity, ∈_{m/HC}, is assigned as the combined dielectric property of the matrix/hydrocarbon phase, using the Complex Refraction Index Model (CRIM). Given the parameters defined above, the effective permittivity of the combined matrix/hydrocarbon mixture is given by:

$$\sqrt{{ϵ}_{m / HC}} = \frac{1 - {ϕ}_{T}}{1 - {ϕ}_{T} + ( 1 - {S}_{w} ) {ϕ}_{T}} \sqrt{{ϵ}_{m}} + \frac{( 1 - {S}_{w} ) {ϕ}_{T}}{1 - {ϕ}_{T} + ( 1 - {S}_{w} ) {ϕ}_{T}} \sqrt{{ϵ}_{HC}} . \qquad ( 1 )$$

This allows the model to be simplified without missing the primary components affecting the dielectric response of rock. In addition, all polarization due to the inclusion of any material (either trapped water droplets or any composite) into a background material are assumed to be approximated by the inclusion of two simple shape type: spherical and oblate spheroidal particles. For a sphere with the permittivity ∈ᵢₙ included in a background with the permittivity ∈_{b}, the polarizability per volume is well-known:

$${α}_{s} ( {ϵ}_{in} , {ϵ}_{b} ) = \frac{{ϵ}_{in} - {ϵ}_{b}}{{ϵ}_{in} + 2 {ϵ}_{b}} . \qquad ( 2 )$$

For a spheroidal grain, the polarizability per volume depends on the orientation of the particle with respect to the externally applied electric field and follow the general form as:

$${α}_{k} ( {ϵ}_{in} , {ϵ}_{b} ) = \frac{1}{3} \frac{{ϵ}_{in} - {ϵ}_{b}}{{L}_{k} {ϵ}_{in} + ( 1 - {L}_{k} ) {ϵ}_{b}} , \qquad ( 3 )$$

with k indicating direction along three principal axes of the spheroid. Here Lₖ are the depolarization coefficient in three direction and defined solely by the shape of the spheroid. Denoting the depolarization coefficient along its axially symmetric principal axis as L≡1−δ with 0<δ<2/3, the coefficients for the two other axes are

$${L}^{′} = \frac{1 - L}{2} = δ / 2.$$

Here, δ depends only on the shape (aspect ratio) of oblate spheroid and serves as the parameters defining the grain shape. Specifically, δ→0 represents the extremely platy oblate spheroidal particle, while δ=2/3 is the spherical limit. By assuming randomly and isotropically oriented particles, the directionally averaged polarization coefficient becomes:

$$〈 {α}_{sphd} ( {ϵ}_{in} , {ϵ}_{b} , δ ) 〉 = \frac{1}{9} ( {ϵ}_{in} - {ϵ}_{b} ) \frac{( 4 - 3 δ ) {ϵ}_{in} + ( 2 + 3 δ ) {ϵ}_{b}}{[ ( 1 - δ ) {ϵ}_{in} + δ {ϵ}_{b} ] [ {δϵ}_{in} + ( 2 - δ ) {ϵ}_{b} ]} . \qquad ( 4 )$$

To include the polarization effect due to the presence of the trapped water droplets, a two-stage model construction procedure is employed. For the hydrocarbon-wet regime, sedimentary rocks contain both isolated and contiguous water, such that the fraction of the effective isolated water is the proxy for wettability. The so-called differential effective medium (DEM) approach is used to model the resultant complex dielectric constant in both stages.

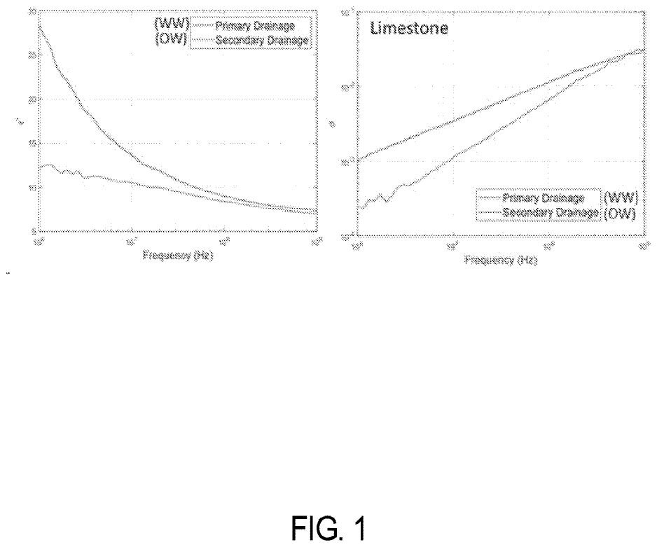

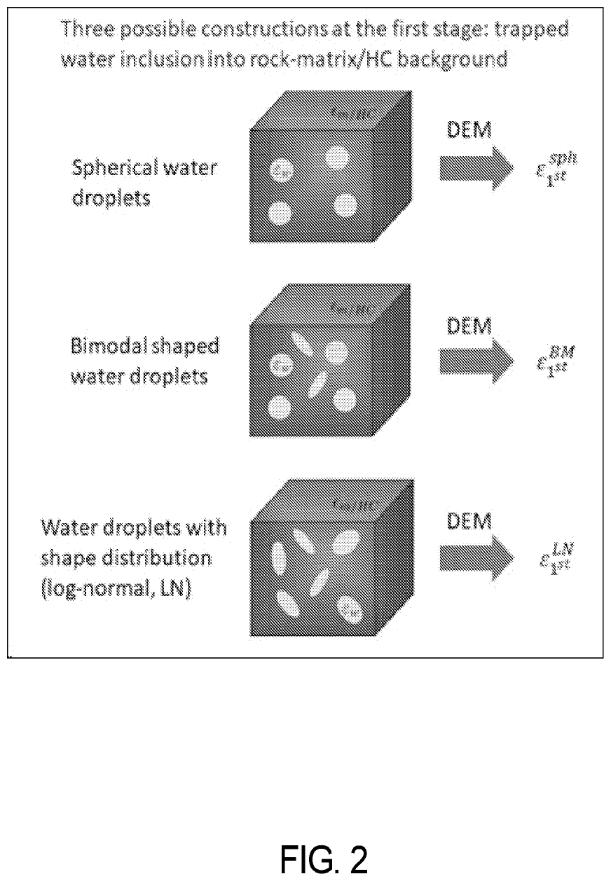

Regarding FIG. 1 schematical plots of three possible first stage constructions by including different shaped water droplets into the rock-matrix/hydrocarbon background are shown. Three cases shown from top to bottom are: spherical water droplets, bimodal (spheres and single shaped spheroids) water droplets, and lognormal shape distributed water droplets. At the first stage, the effective dielectric constant, ε₁ₛₜ, for the rock-matrix/hydrocarbon/trapped-water-droplets composite is modeled and computed by adding water droplets into the nonconductive rock-matrix/hydrocarbon background, as schematically shown in FIG. 2. Here, the rock matrix/hydrocarbon mixture is treated as a single phase, nonconductive material as in Eq. (1), and is used as the initial background for DEM approach. Three possible constructions are shown in FIG. 2: (1) spherical water droplets, (2) bimodal shaped (spheres and single shaped spheroids) water droplets, and (3) lognormal (LN) shape distributed water droplets.

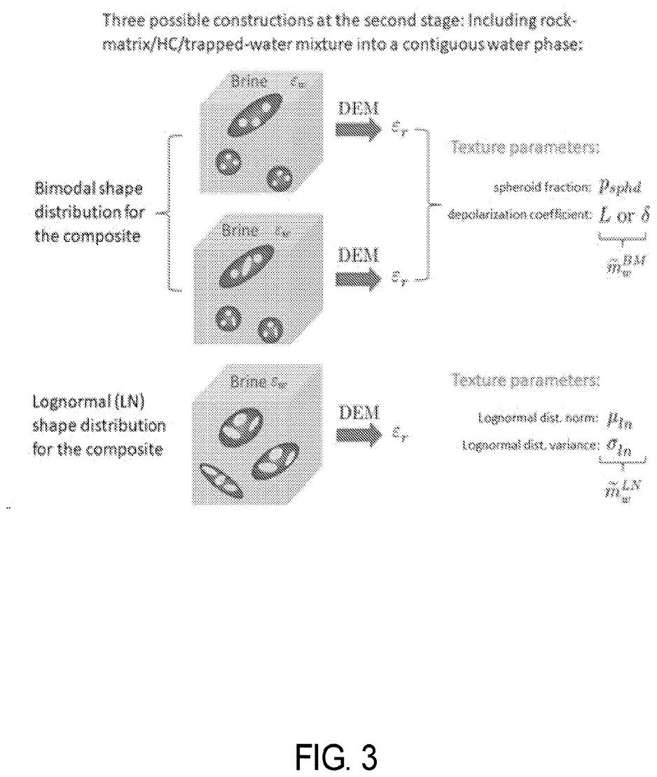

At the second stage, the effective dielectric constant, ε₁ₛₜ, is used for the rock-matrix/HC/trapped-water composite particles immersed in the contiguous water, as depicted in FIG. 3. Again, the DEM approach is used to compute the dielectric constant and yield the predicted complex dielectric dispersion, εᵣ, of the formation. Three possible second stage constructions are shown in FIG. 3: (1) spherical water droplets with bimodal shapes for the composite particles, (2) bimodal-bimodal shapes for both water droplets and composite particles, and (3) LN-LN shape distribution for both water droplets and composite particles. In principle, both the trapped water droplets in the first stage and the composite grains in the second stage can take any tractable shape distribution, such as the bimodal, lognormal, or even multimodal distributions. Also, the associated texture parameters defining the shapes and distributions of droplets and grains in two stages can in principle be entirely uncorrelated, but that will result in doubling the number of textual parameters. To have a maximally parsimonious model, the texture parameters, as defined later, for the first and the second stages of inclusion can be set to be identical.

Regarding FIG. 2, schematic plots of three possible constructions at the second stage for the inclusion of matrix/HC/water droplet composite into the conductive background. Three cases shown from top to bottom are: spherical water droplets with bimodal shapes for the composite, bimodal-bimodal (spheres and single shaped spheroids) construction, and LN-LN shape distribution construction.

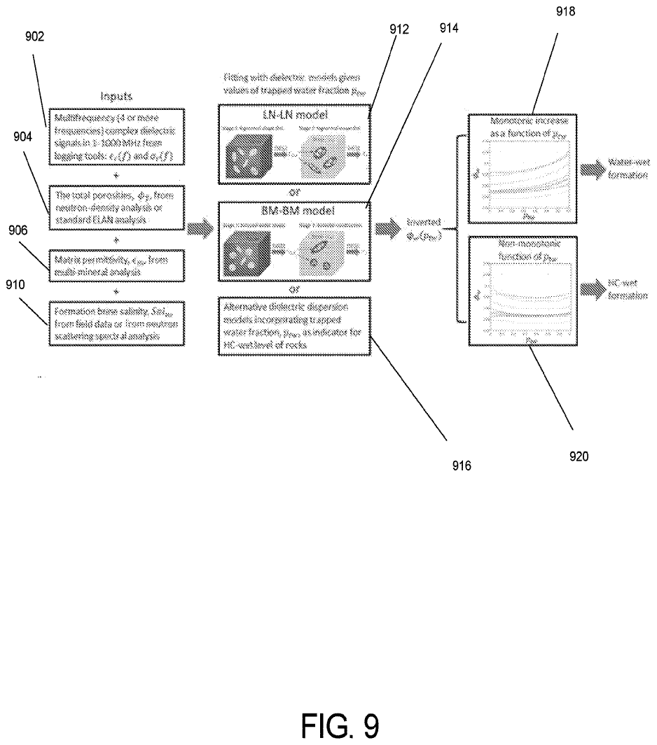

Intuitively, the inclusion of isolated water into the non-conductive materials at the first stage is intended to model the water pockets cut off by the transition from the water-wet to the oil-wet regime. In a physical picture of the matrix being built up from a homogeneous rock-matrix/HC medium that is uniformly and randomly studded with isolated water pockets, the DEM theory can naturally be employed to compute an effective dielectric constant. Another potential way to include the trapped water droplets in modeling the dielectric dispersion is to put a single, specifically shaped water pocket at the dead center of each individual matrix grain. Such approach can yield similar model responses compared to corresponding two-stage constructions in appropriate limits, but potentially with more unnecessary parameters. However, the workflow established here can also be applied to such alternative model construction procedure (See FIG. 9, 916). Two specific constructions, (a) bimodal-bimodal distribution for both stages (see FIG. 9, 914) and (b) LN-LN distribution (see FIG. 9, 912) for both stages, are discussed below. As having spherical water droplets at the first stage can be treated as a special limit for the bimodal distribution, the detailed construction procedure for such case is skipped.

### Bimodal-Bimodal (BM-BM) Model:

First, required texture parameters for bimodal shape distribution are defined, which are shared at both stages, as:
δ: The shape parameter of the oblate spheroid, which is associated with the depolarization coefficient, L, along the axial-symmetry axis as δ=1−L.
p_{sphd}: The volume fraction of spheroids among water droplets at first stage or among composite grains at the second stage.

At the first stage, the trapped brine “droplets” are added into a “background”. Following the DEM approach, the initial background for the inclusion is taken as the rock-matrix/HC mixture with its permittivity ∈_{m/HC}, which gives an implicit equation for the first stage dielectric constant,

$${ε}_{1 st}^{BM} ,$$

as:

$$( 1 - \frac{{ϕ}_{T} {S}_{w} {p}_{tw}}{1 - {ϕ}_{T} {S}_{w} ( 1 - {p}_{tw} )} ) = {\prod }_{i = 0}^{3} {( \frac{{ϵ}_{m / HC} - {λ}_{i}^{BM , 1 st}}{{ε}_{1 st}^{BM} - {λ}_{i}^{BM , 1 st}} )}^{{ρ}_{i}^{BM , 1 st}} , \qquad ( 5 )$$

where

$${λ}_{i}^{BM , 1 st} and {ρ}_{i}^{BM , 1 st}$$

are poles and residues defined by

$$\frac{1}{3 ϵ {\overline{P}}_{BM}^{1 st} ( ϵ )} = {\sum }_{i = 0}^{3} \frac{{ρ}_{i}^{BM , 1 st}}{ϵ - {λ}_{i}^{BM , 1 st}} , \qquad ( 6 )$$

with

$${\overline{P}}_{BM}^{1 st} ( ϵ ) = ( 1 - {p}_{sphd} ) {α}_{s} ( {ε}_{w} , ϵ ) + {p}_{sphd} 〈 {α}_{sphd} ( {ε}_{w} , ϵ , δ ) 〉 . \qquad ( 7 )$$

Here the functional form of αₛ(ε_{w},∈) and [symbol] α_{sphd}(ε_{w},∈,δ) [symbol] are defined in Eqs. (2) and (3), respectively. The Eq. (5) can straightforwardly be solved by numeric methods.

At the second stage, the rock-matrix/HC/trapped water droplet composite with complex dielectric constant

$${ε}_{1 st}^{BM} ,$$

is treated as the inclusion phase to be included into the background. Taking the water phase as the initial background and following the DEM construction to reach the desired contiguous water volume fraction, one obtains eventual implicit equation for the modeled complex dielectric constant,

$${ε}_{r}^{BM - BM} ,$$

as:

$$( 1 - {p}_{tw} ) {ϕ}_{T} {S}_{w} = {\prod }_{i = 0}^{3} {( \frac{{ε}_{w} - {λ}_{i}^{BM , 2 nd}}{{ε}_{r}^{BM - BM} - {λ}_{i}^{BM , 2 nd}} )}^{{ρ}_{t}^{BM , 2 nd}} . \qquad ( 8 )$$

Like the first stage,

$${λ}_{i}^{BM , 2 nd} and {ρ}_{i}^{BM , 2 nd}$$

are poles and residues defined by

$$\frac{1}{3 ϵ {\overline{P}}_{BM}^{2 nd} ( ϵ )} = {\sum }_{i = 0}^{3} \frac{{ρ}_{i}^{BM , 2 nd}}{ϵ - {λ}_{i}^{BM , 2 nd}} , \qquad ( 9 )$$

with

$${\overline{P}}_{BM}^{2 nd} ( ϵ ) = ( 1 - {p}_{sphd} ) {α}_{s} ( {ε}_{1 st}^{BM} , ϵ ) + {p}_{sphd } 〈 {α}_{sphd} ( {ε}_{1 st}^{BM} , ϵ , δ ) 〉 . \qquad ( 10 )$$

The resultant complex dielectric constant is often separated into the real and imaginary part with the relation,

$${ε}_{r}^{BM - BM} = {ϵ}_{r}^{BM - BM} + i {σ}_{r}^{BM - BM} / {ϵ}_{0} ω .$$

### Here,

$${ϵ}_{r}^{BM - BM}$$

is the relative permittivity and

$${σ}_{r}^{BM - BM}$$

is conductivity from the model prediction. In the de limit, the model predicted conductivity follows the Archie-like relation for contiguous water phase,

$${σ}_{r}^{BM - BM} = {{σ}_{w} ( ( 1 - {p}_{tw} ) {S}_{w} {ϕ}_{T} )}^{{\tilde{m}}_{w}^{BM - BM}} ,$$

with

$${\tilde{m}}_{w}^{BM - BM} = ( 1 - {p}_{sphd} ) \frac{3}{2} + {p}_{sphd} \frac{2 + 3 δ}{3 δ ( 2 - δ )} . \qquad ( 11 )$$

The exponent

$${\tilde{m}}_{w}^{BM - BM}$$

is referred as contiguous water phase tortuosity exponent. Giving the values of δ and p_{sphd} uniquely define the exponent

$${\tilde{m}}_{w}^{BM - BM} .$$

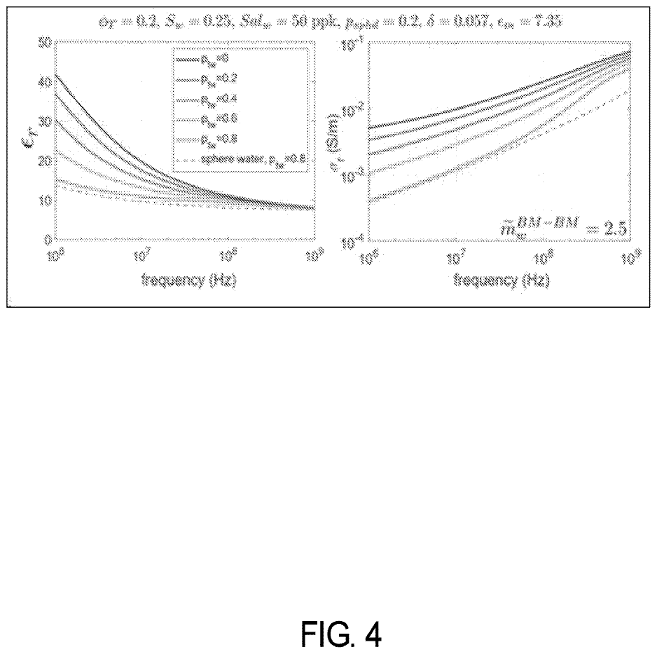

Referring to FIG. 4, the typical relative permittivity and conductivity dispersion in 1-1000 MHz for the two-stage BM-BM construction, with varying amounts of ETWF

Typical complex dielectric responses of the two-stage BM-BM construction in the frequency range of 1-1000 MHz are shown in FIG. 4. With the increase values of p_{tw}, the conductivity reduces accompanying with the less dispersive relative permittivity, which is consistent with the observed dielectric response for a transition from water-wet regime to HC-wet regime. For comparison, the model dielectric response for spherical water droplets-BM construction with p_{tw}=0.8 is included in FIG. 4. One observes an apparent convergence of conductivity at higher frequency end for the BM-BM model.

### Lognormal-Lognormal (LN-LN) Model:

To define the lognormal distribution for the model construction, a parameterization of the shape parameters δ is introduced as:

$$δ ( ξ ) = 1 + ( 1 + {ξ}^{2} ) ( ξ {tan}^{- 1} ( \frac{1}{ξ} ) - 1 ) . \qquad ( 12 )$$

Here 0<ξ<∞ is the effective radius parameter of an oblate spheroid in the oblate spheroidal coordinates. The parameter ξ can be related to the aspect ratio of the oblate spheroid as with a and b the length of major and minor axes of the oblate spheroid,

$$AR = \frac{b}{a} = \frac{ξ}{\sqrt{1 + {ξ}^{2}}}$$

with a and b the length of major and minor axes of the oblate spheroid, respectively.

The lognormal distribution is then defined with parameter, ¿, as

$${P}_{ln} ( ξ ) = \frac{1}{\sqrt{2 π} {σ}_{ln} ξ} exp ( - \frac{{( ln ξ - {μ}_{ln} )}^{2}}{2 {σ}_{ln}^{2}} ) . \qquad ( 13 )$$

which is controlled by the mean μₗₙ and the variance σₗₙ of the lognormal distribution. The texture parameters for the LN-LN model are then given by:
μₗₙ: The mean of the lognormal distribution defined in Eq. (13).
σₗₙ: The variance of the lognormal distribution defined in Eq. (13).

Such continuous shape distribution can be approximated by an ensemble of spheroidal particles by n discretized shapes. This effectively gives rise to a pair of arrays, (δ₁, δ₂, . . . , δₙ)_{μ}_{ₗₙ}_{,σ}_{ₗₙ} and (p₁, p₂ . . . , pₙ)_{μ}_{ₗₙ}_{,σ}_{ₗₙ}, for corresponding shapes and volume fractions. Because the lognormal model is controlled by only two texture parameters even though it utilizes multi-modal shape distribution, it has the same number of model parameters as that of the BM-BM.

Like the BM-BM model, the trapped brine “droplets” are added into a “background” at the first stage with the initial background taken as the rock-matrix/HC mixture with its permittivity ∈_{m/HC}. Following the DEM approach, an implicit equation for the first stage dielectric constant,

$${ε}_{1 st}^{LN} ,$$

is derived as:

$$( 1 - \frac{{ϕ}_{T} {S}_{w} {p}_{tw}}{1 - {ϕ}_{T} {S}_{w} ( 1 - {p}_{tw} )} ) = {\prod }_{i = 0}^{2 n} {( \frac{{ϵ}_{m / HC} - {λ}_{i}^{LN , 1 st}}{{ε}_{1 st}^{LN} - {λ}_{i}^{LN , 1 st}} )}^{{ρ}_{i}^{LN , 1 st}} , \qquad ( 14 )$$

where

$${λ}_{i}^{LN , 1 st} and {ρ}_{i}^{LN , 1 st}$$

are poles and residues defined by

$$\frac{1}{3 ϵ {\overline{P}}_{LN}^{1 st} ( ϵ )} = {\sum }_{i = 0}^{2 n} \frac{{ρ}_{i}^{LN , 1 st}}{ϵ - {λ}_{i}^{LN , 1 st}} , \qquad ( 15 )$$

with with

$${\overline{P}}_{L N}^{1 s t} ( ϵ ) = {\sum }_{i = 1}^{n} {p}_{i} 〈 {α}_{s p h d} ( {ε}_{w} , ϵ , {δ}_{i} ) 〉 . \qquad ( 16 )$$

Here the functional form of [symbol] α_{sphd}(ε_{w},∈,δᵢ) [symbol] are defined in Eq. (3).

The eventual implicit equation for the modeled complex dielectric constant,

$${ε}_{r}^{L N - L N} ,$$

can be similarly derived as:

$$( 1 - {p}_{t w} ) {ϕ}_{T} {S}_{w} = {\prod }_{i = 0}^{2 n} {( \frac{{ε}_{w} - {λ}_{i}^{LN , 2 nd}}{{ε}_{r}^{L N - L N} - {λ}_{i}^{L N , 2 nd}} )}^{{ρ}_{i}^{LN , 2 nd}} . \qquad ( 17 )$$

Like the first stage,

$${λ}_{i}^{L N , 2 nd} and {ρ}_{i}^{L N , 2 nd}$$

are poles and residues defined by

$$\frac{1}{3 ϵ {\overline{P}}_{L N}^{2 n d} ( ϵ )} = {\sum }_{i = 0}^{2 n} \frac{{ρ}_{i}^{LN , 2 nd}}{ϵ - {λ}_{i}^{LN , 2 nd}} , \qquad ( 18 )$$

with

$${\overline{P}}_{L N}^{2 nd} ( ϵ ) = {\sum }_{i = 1}^{n} {p}_{i} 〈 {α}_{sphd} ( {ε}_{1 st}^{L N} , ϵ , {δ}_{i} ) 〉 . \qquad ( 19 )$$

The resultant complex dielectric constant is often separated into the real and imaginary part with the relation,

$${ϵ}_{r}^{L N - L N} = {ϵ}_{r}^{L N - L N} + i {σ}_{r}^{L N - L N} / {ϵ}_{0} ω .$$

In the dc limit, the model predicted conductivity follows the Archie-like relation for contiguous water phase,

$${σ}_{r}^{L N - L N} = {{σ}_{w} ( ( 1 - {p}_{t w} ) {S}_{w} {ϕ}_{T} )}^{{\tilde{m}}_{w}^{L N - L N}} ,$$

with

$${\tilde{m}}_{w}^{L N - L N} = {\sum }_{\dot{ι} = 1}^{n} {p}_{i} \frac{2 + 3 {δ}_{i}}{3 {δ}_{i} ( 2 - {δ}_{i} )} . \qquad ( 20 )$$

Similarly, the exponent

$${\tilde{m}}_{w}^{L N - L N}$$

can be referred as contiguous water phase tortuosity exponent. Giving the values of μₗₙ and σₗₙ uniquely define the exponent

$${\tilde{m}}_{w}^{L N - L N} .$$

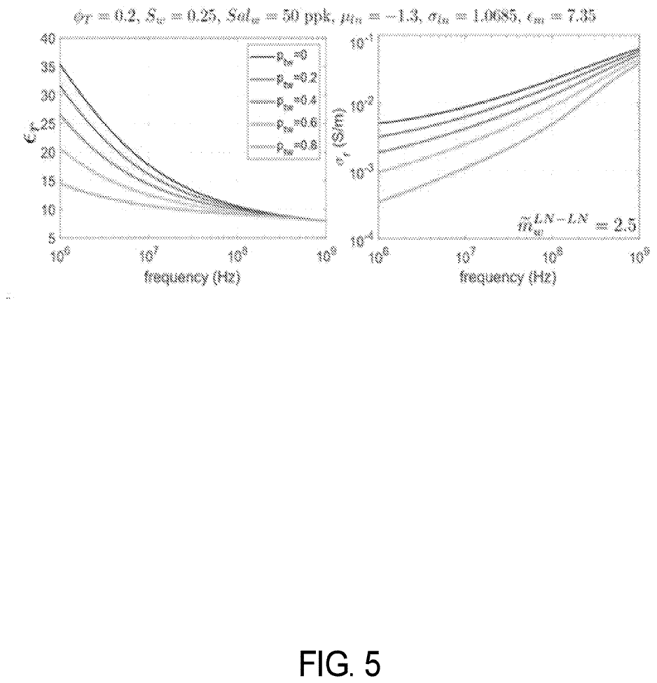

Referring to FIG. 3: Typical relative permittivity and conductivity dispersion in 1-1000 MHz for the two-stage LN-LN construction, with varying amounts of ETWF. Typical complex dielectric responses of the two-stage LN-LN construction in the frequency range of 1-1000 MHz are shown in FIG. 5. Like the BM-BM model, with the increase values of p_{tw}, the conductivity reduces accompanying with the less dispersive relative permittivity, which is consistent with the observed dielectric response for a transition from water-wet regime to HC-wet regime. One also observes an apparent convergence of conductivity at higher frequency end for the LN-LN model. In general, LN-LN model can behave very similarly compared to the BM-BM model, especially for a smaller frequency range. However, the dielectric dispersion of LN-LN model is normally much smoother as it consists of a broader spectrum of characteristic frequency. Hence, the workflow demonstrated below will utilize the LN-LN model.

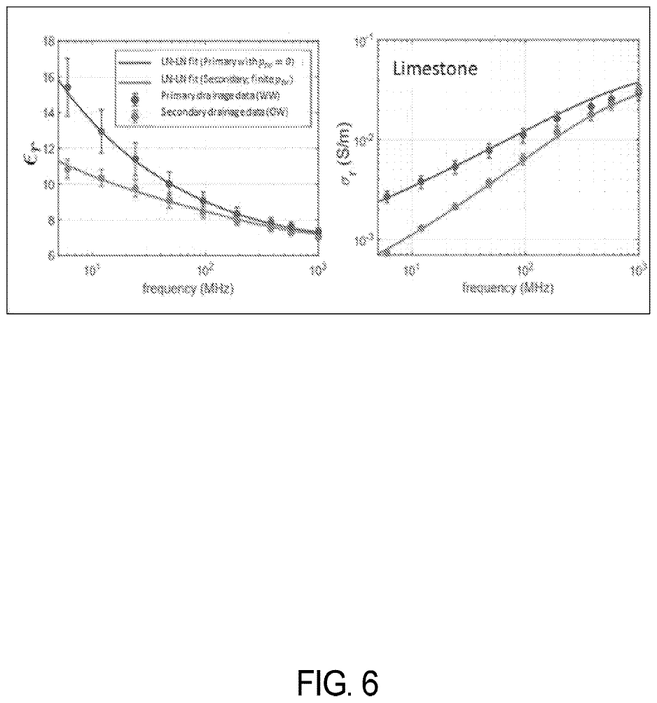

To demonstrate that the newly establish models can be used to describe the dielectric dispersion associated with the wettability change, a least square fitting process is employed to fit the experimental dataset shown in FIG. 1. Two sets of dielectric dispersion signals are measured from the same core but at different wettability states. Incidentally, the residue water volumes are similar at both water-wet and HC-wet state. Hence, based on the physical picture of our model, the “significant” difference between two sets of dielectric dispersion should come from the trapped water fraction, p_{tw}. In FIG. 6, dielectric dispersion at both water-wet and HC-wet states are jointly fitted with a common set of modeling parameters: μₗₙ, σₗₙ, and S_{w}. The brine salinity and total porosity of the core are known and used as an input in the model fitting process. The sample at the water-wet state is assumed to have p_{tw}=0, while a finite value of p_{tw}=0.63 is obtained from the fitting process for sample at the HC-wet state. Also, the fit yields a value of S_{w} like that inferred from other measurements. The good fit obtained by this joint fitting exercise supports our model picture by associating the HC-wet state with the presence of trapped water droplets.

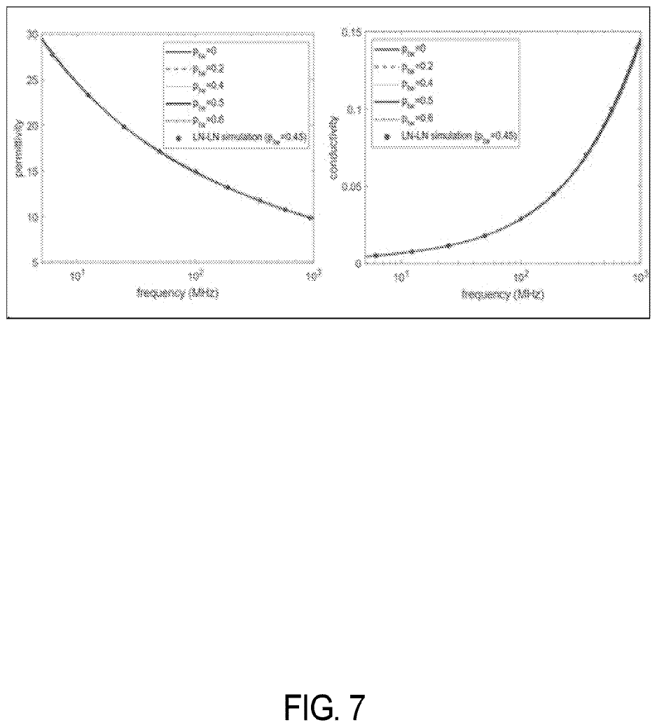

Although the fitting results shown in FIG. 6 do support the modeling picture, it is important to point out that such joint fitting process cannot be translated for practical applications. In most typical cases, one would have only one set of complex dielectric dispersion data with unknown wettability states. Ideally, one would like to utilize the least square fit process to invert for the model parameters and then to use the inverted value of p_{tw} as a direct indicator. However, as pointed out by earlier works and depicted in FIG. 7, it could be difficult to disentangle the effect due to wettability changes, approximated by p_{tw}, from influences of all other model parameters. In FIG. 7, the multi-frequency dielectric signals are simulated using the LN-LN model with p_{tw}=0.45. The fitting is also performed using LN-LN model, given brine salinity Sal_{w}, total porosity φ_{T}, and fixed values of p_{tw}. One observes that reasonable fits are obtains for all values of p_{tw}. Hence, considering the uncertainty associated with real measurements, directly inverting for the value of p_{tw} and using it as an indicator for the wettability states can be very difficult and unreliable.

Regarding FIG. 4, the fitting studies on simulated LN-LN model data with p_{tw}=0.45. The fittings are also performed with the LN-LN model with different and fixed values of p_{tw}. Reasonably good fits are obtained for all values of p_{tw}.

However, interesting trends appear from the inverted physical parameters obtained in the fitting process based on the simulated dielectric dispersion. To start, the dielectric dispersions for water-wet rocks are simulated by LN-LN model with p_{tw}=0, while for HC-wet rocks are simulated with p_{tw}=0.55-0.65. A range of model parameters, \tilde{m}_{w}=2-4, Sal_{w}=32-100 kppm, and φ_{T}=0.18-0.28, are used for simulation.

Referring to FIG. 5: The inverted φ_{w}(p_{tw}) for simulated dielectric dispersions of (a) water-wet and (b) HC-wet cases is illustrated.

Given the brine salinity and the total porosity, these simulated dielectric dispersions are fitted with LN-LN model with different values of p_{tw}, which give the inverted parameters S_{w}(p_{tw}) and

$${\tilde{m}}_{w}^{L N - L N} ( {p}_{t w} )$$

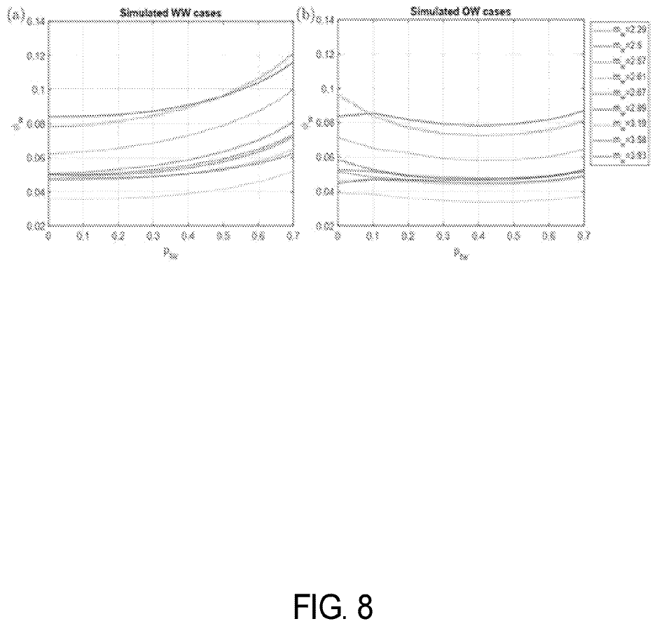

as a function of p_{tw}. Let us focus on S_{w}(p_{tw}). FIG. 8 shows the response of φ_{w}(p_{tw})=φ_{T}S_{w}(p_{tw}) for different simulated examples. For water-wet cases, FIG. 8 (left side), φ_{w}(p_{tw}) generally shows the monotonic increase feature with the increasing values of p_{tw}. For HC-wet case, FIG. 8 (right side), shows much less variation and a non-monotonic response with the increasing values of p_{tw}. Such qualitative different response, if surviving with real dielectric dispersion, can be used to delineating rocks' wettability states.

The proposed workflow enabling us to distinguish wettability states of formations from multi-frequency dielectric signals in the frequency range of 1 MHz to a few GHz is illustrated in FIG. 9.

Referring to FIG. 9, the illustration of the proposed workflow for delineating the wettability states of the formation is provided.

The required inputs for the workflow are:
At 902 the complex dielectric dispersion signals, ∈ᵣ(f) and σᵣ, between 1-1000 MHz: Multi-frequency dielectric signals measured from a typical dielectric logging tools in the frequency range of 20-1000 MHz with 4-5 frequency selections are sufficient for the workflow. However, one can potentially combine dielectric signals from multiple tools in 1-1000 MHz range to offer dielectric signals in a broad frequency range.
At 904, the total porosity, φ_{T}, of the formation: The φ_{T} can be inferred from various standard methods, such as neutron-density analysis, ELAN or Quanti-ELAN analysis.
At 906, matrix permittivity, ∈ₘ: The matrix permittivity can be obtained by standard multi-mineral analysis.
At 908, relative permittivity of HC, ∈_{HC}: the relative permittivity of HC only varies within a small range, 2<∈_{HC}<2.2. Hence, one can take a typical value if there is no trustworthy benchmark.
At 910, the formation brine salinity: The brine salinity is a needed input from prior knowledge or obtained from the neutron scattering spectral analysis for the chlorine concentration.
   Other commonly available parameters, such as formation temperature and pressure, are also needed as inputs.

In the next step, we utilize dielectric dispersion model, that include the trapped water fraction, p_{tw}, to capture polarization effect of fluid (re) distribution due to wettability changes from water-wet to HC-wet. Typically, such dielectric model is governed by the following parameters: (1) the relative permittivity of rock matrix, ∈ₘ; (2) the relative permittivity of HC, ∈_{HC}; (3) the total porosity of the rock, φ_{T}; (4) the brine salinity, Sal_{w}; (5) the water saturation fraction, S_{w}; (6) texture parameters, such as (δ, p_{sphd}) for BM-BM model and (μₗₙ, σₗₙ) for LN-LN model (for 912); and (7) the effective trapped water fraction among all water volume, p_{tw}. Given all the inputs listed above with a fixed value of p_{tw}, only three parameters, S_{w} and two texture parameters, are varied to obtain the best fit between the dielectric model and the measured dielectric dispersion data. A standard least square fit by minimizing a cost is used to obtain the best fit. The general form of the cost function can be defined as

$$cost = {\sum }_{i = 1}^{n} \frac{{( {ϵ}_{r} ( {f}_{i} ) - {ϵ}_{r}^{model} ( {f}_{i} ) )}^{2}}{{W}_{ϵ , i}^{2}} + {\sum }_{i = 1}^{n} \frac{{( {σ}_{r} ( {f}_{i} ) - {σ}_{r}^{model} ( {f}_{i} ) )}^{2}}{{W}_{σ , i}^{2}} . \qquad ( 21 )$$

Here, dielectric signals are measured in n-frequencies, f₁, f₂, . . . , fₙ, and

$${ϵ}_{r}^{model} ( {f}_{i} )$$

$$and {σ}_{r}^{model} ( {f}_{i} )$$

are modeled relative permittivity and conductivity at frequency, fᵢ, with a given set of parameters. The weight constants, W_{∈,i} and W_{σ,i}, can be chosen to be the measurement error/uncertainty or other normalization values to make each data points more equal weighted. Variation of cost functions may also be used to achieve more stable fitting/inversion results. For instance, taking logarithm on certain measured signals spanning over several order of magnitude is a natural way to make all data points more equally weighted.

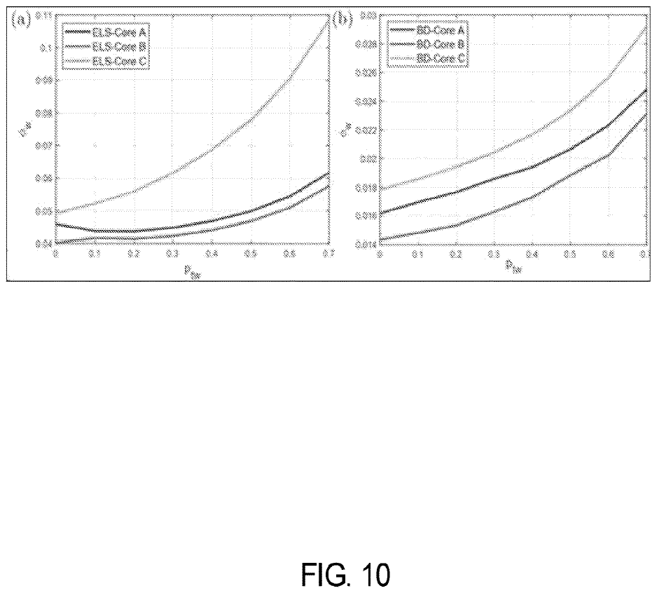

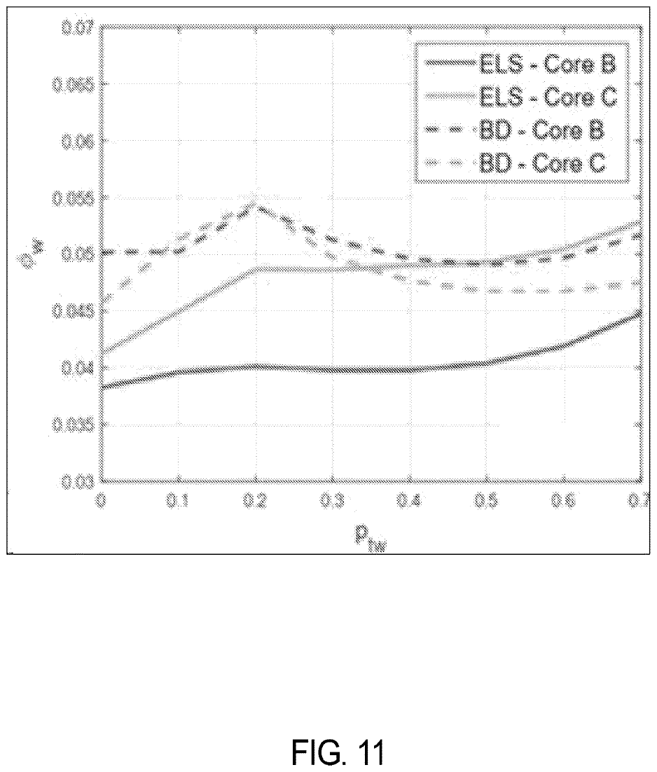

Minimizing the cost shown in Eq. (21) with a given model gives the inverted model parameters. By varying values of p_{tw}, one obtains the inverted model parameters as a function of the effective trapped water fraction, p_{tw}. As discussed earlier, we focus on the inverted φ_{w}(p_{tw}) to delineate the water-wet and HC-wet rocks. FIG. 10 shows examples of inverted φ_{w}(p_{tw}) from the measured dielectric signals of six water-wet cores by going through the proposed workflow illustrated in FIG. 9. Predominantly, the inverted φ_{w} increases monotonically with the increasing value of p_{tw} as shown in 918. This is consistent with the pattern shown in FIG. 8 (left side), which allows us to unambiguously identify the cores as water-wet. In FIG. 11, examples of inverted φ_{w}(p_{tw}) from the measured dielectric signals for four HC-wet cores are shown. All HC-wet cores show non-monotonic behaviors at 920 accompanying with a much weaker variation for the inverted φ_{w}, which is consistent with what observed in FIG. 8 (right side). This allows us to conclude that those cores are indeed in HC-wet state. FIG. 10 illustrates the inverted φ_{w}(p_{tw}) for six water-wet cores from their measured dielectric dispersion following the established workflow. FIG. 11 illustrates the inverted φ_{w}(p_{tw}) for four HC-wet cores from their measured dielectric dispersion following the established workflow.

The inverted φ_{w}(p_{tw}) responses shown in FIGS. 10 and 11 uses dielectric signals in 9 frequencies between 6-1000 MHz. However, the observed patterns allowing us to distinguish water-wet and HC-wet rocks are very robust. Similar qualitative behaviors are observed if one uses dielectric signals in only 4 frequencies between 20-1000 MHz, which mimics the sampling rate and the frequency range of existing multi-frequency dielectric logging tool.

In one example embodiment of the disclosure, a method is disclosed. The method may comprise obtaining dielectric dispersion signals of a formation and obtaining a total porosity of the formation. The method may also comprise obtaining a dielectric dispersion model that includes a polarization response of trapped water droplets to indicate a wettability change of the formation; and processing the dielectric dispersion signals and the total porosity of the formation with the model to determine a wettability state of rock in the formation.

In another example embodiment, the method may be performed wherein the dielectric models are in a frequency range of 1 MHZ to 3 GHZ.

In another example embodiment, the method may be performed wherein the dielectric dispersion signals are measured from a typical dielectric logging tool.

In another example embodiment, the method may be performed wherein the signals are in a frequency range of 20-1000 MHz.

In another example embodiment, the method may be performed wherein an effective trapped water fraction is used as a proxy for indications of wettability.

In another example embodiment, the method may be performed wherein the dielectric dispersion signals are combined with at least one petrophysical measurement to reduce an uncertainty of estimated rock and fluid properties.

In another example embodiment, the method may be performed wherein the at least one petrophysical measurement includes at least one of a resistivity and a nuclear magnetic resonance measurement.

In another example embodiment, the method may be performed wherein the at least one petrophysical measurement includes at least one nuclear measurement.

In another example embodiment, the method further comprise obtaining a salinity of a fluid from the formation, wherein the salinity is used by the dielectric dispersion model

In another example embodiment, the method may be performed wherein an effective trapped water fraction is used as a proxy for indications of wettability.

In another example embodiment, a computer readable storage medium having data stored therein representing software executable by a computer is disclosed. In this embodiment, the software may including instructions for obtaining dielectric dispersion signals of a formation, obtaining a total porosity of the formation, obtaining a dielectric dispersion model that includes a polarization response of trapped water droplets to indicate a wettability change of the formation and processing the dielectric dispersion signals and the total porosity of the formation with the model to determine a wettability state of rock in the formation.

In another example embodiment, the method may be performed wherein the instructions include the signals are in a frequency range of 20-1000 MHz.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method, comprising:
obtaining dielectric dispersion signals of a formation;
obtaining a total porosity of the formation;
obtaining a dielectric dispersion model that includes a polarization response of trapped water droplets to indicate a wettability change of the formation; and
processing the dielectric dispersion signals and the total porosity of the formation with the model to determine a wettability state of rock in the formation.

2. The method according to claim 1, wherein the dielectric models are in a frequency range of 1 MHZ to 3 GHZ.

3. The method according to claim 1, wherein the dielectric dispersion signals are measured from a typical dielectric logging tool.

4. The method according to claim 2, wherein the signals are in a frequency range of 20-1000 MHz.

5. The method of claim 1, wherein an effective trapped water fraction is used as a proxy for indications of wettability.

6. The method of claim 1, wherein the dielectric dispersion signals are combined with at least one petrophysical measurement to reduce an uncertainty of estimated rock and fluid properties.

7. The method of claim 1, wherein the at least one petrophysical measurement includes at least one of a resistivity and a nuclear magnetic resonance measurement.

8. The method of claim 1, wherein the at least one petrophysical measurement includes at least one nuclear measurement.

9. The method of claim 1, further comprising:
obtaining a salinity of a fluid from the formation, wherein the salinity is used by the dielectric dispersion model.

10. The method according to claim 1, wherein an effective trapped water fraction is used as a proxy for indications of wettability.

11. A computer readable storage medium having data stored therein representing software executable by a computer, the software including instructions for
obtaining dielectric dispersion signals of a formation;
obtaining a total porosity of the formation;
obtaining a dielectric dispersion model that includes a polarization response of trapped water droplets to indicate a wettability change of the formation; and
processing the dielectric dispersion signals and the total porosity of the formation with the model to determine a wettability state of rock in the formation.

12. The computer readable storage medium of claim 11, wherein the instructions include the signals are in a frequency range of 20-1000 MHZ.
